(19) United States
(12) Patent Application Publication
(10) Pub. No.: US 2009/0254425 A1
(43) Pub. Date: Oct. 8, 2009

(54) WIKI-TYPE COLLECTIVE INTELLIGENCE MECHANISM FOR IMPLEMENTING A URL REDIRECT

(76) Inventors: Evan Horowitz, San Francisco, CA (US); Michael Landau, Greenbrae, CA (US); Rodney Weiss, San Francisco, CA (US)

Correspondence Address: PERKINS COIE LLP, P.O. BOX 1208, SEATTLE, WA, 98111-1208, US

(21) Appl. No.: 12/061,490

(22) Filed: Apr. 2, 2008

(51) Int. Cl. G06Q 30/00; G06F 7/06; G06F 17/30

(52) U.S. Cl. 705/14; 707/3; 707/103 R; 707/E17.014

(57) ABSTRACT

A computer system implements a method to redirect a user request containing a keyword to a target URL. Once received by the system, the user request is processed to extract the keyword. The keyword is then utilized to retrieve a target URL associated with the keyword. Such association is pre-established by the collective intelligence of a user community. The collective intelligence of the user community builds consensuses in establishing keyword-URL associations. After the target URL is retrieved, the user request is redirected to the target URL, as a response to the original user request received.

### FIELD OF THE INVENTION

At least one embodiment of the present invention pertains to Wiki-type collective intelligence URL redirection, and more particularly to a Wiki-type URL redirection based on the collective intelligence of a user community.

### BACKGROUND

Internet search engines, provided by companies such as GOOGLE® or YAHOO®, are designed to help users find information located on the World Wide Web. Search engines typically perform three basic tasks: they mine data available in web sites, newsgroups, databases, or open directories, etc; they index keywords found in the mined data with the locations the mined data is found; and they allow users to search for information based on indexed keywords. Data mining is usually performed by automated software such as a web crawler. Indexing is usually based on certain algorithms in order to facilitate fast and accurate retrieval. And when a user conducts a search based on indexed keywords, search engines return a list containing hundreds, sometimes even millions, of search results. It's up to the user to check each of the returned results in hope of finding what he is looking for.

Thus, the accuracy of a search depends on the search engine and its data mining scope, its indexing algorithms, and the number of search results returned. Except in certain cases, when the frequency of a specific searched keyword is fed back to a search engine for fine-tuning its indexing algorithms, a user has little-to-no control as to the search engine's data mining or keyword indexing or results. Even when the user is able to locate the “needle” of information from the “haystack” of search results, his or her effort spent on the information quest is not preserved for the benefit of another user. Thus, a different approach in providing keyword searching is highly desirable. Such approach should first, allow a user to supply sources of data, instead of relying on discovery by web crawler's infrequent visits; second, enable a user to customize keyword indexing to a source of data, instead of relying on search engine's indexing algorithms; and lastly, direct a user search request to its most “accurate” destination, instead of filtering through hundreds of search results.

Recent collaborative technologies enable web users to participate in the building of web content and web structures. A typical collaborative technology is a Wiki, a software application that allows users to freely create and edit web page contents using web browsers. The power of a Wiki is not in its technology, but in its user community, which encourages democratic use of the web and promotes content composition by all users. An example of such a Wiki community is Wikipedia, which becomes arguably the best online encyclopedia with over 10 million articles covering a vast amount of topics and subjects.

Still, software such as a Wiki is not adapted to provide customized indexing of keywords for searching information on the Internet. Nor is a Wiki capable of providing non-stop direct access to the best destination for a specific keyword. Thus, a solution is desirable to provide a direct response to a user request, by directing the user request straight to the most authoritative source, while allowing user collaboration and contribution to the indexing of search keywords and search targets.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a system environment in which the present invention can be implemented;

FIG. 2 shows multiple exemplary scenarios of keyword indexing;

FIG. 3 illustrates an environment for keyword indexing based on collaborative intelligence of a user community;

FIG. 4 illustrates a flow diagram showing user request redirecting;

FIG. 5 illustrates a flow diagram showing keyword indexing; and

FIGS. 6A-6C illustrate exemplary user interfaces in building keyword indexing.

### DETAILED DESCRIPTION

Methods and systems for a Wiki-type collective intelligence mechanism for implementing URL redirection are described. In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

In one embodiment of the present invention, a user request containing a keyword is redirected to the most relevant target according to the collective intelligence of a user community. A user request may be received via multiple mechanisms, such as from a Uniform Resource Locator (URL) address bar, or from a HyperText Markup Language (HTML) form, of a web browser. Alternatively, a user request may be received via a network communication originated from a user-invoked or an event-triggered software program. The keyword, or key phrase, contained in the user request is used to locate the most relevant resource containing the requested information.

In one embodiment, the user request is redirected to the most relevant target's URL. URL is a term used for identifying the location of a resource on the Internet. URL redirection is a technique for making one piece of information available from multiple URL addresses. Thus, when a user requests information identified by a first URL, URL redirection relays the request to a second URL, and responds to the user with the results obtained from the second URL.

In one embodiment, collective intelligence is utilized in the indexing of keywords to target URLs. Indexing refers to the direct or indirect association between a keyword and its respective target URL. The resulting keyword-URL mapping could be used for URL redirection of a user request containing the indexed keyword to the indexed URL. Collective intelligence refers to a form of intelligence that emerges from the collaboration and/or competition of a community of users. Thus, opinions from the consent of the community, rather than from any individual user, dictate the collective intelligence of the community in constructing the keyword-URL indicies. To effectively retrieve collective intelligence from a user community, a set of rules and criteria must be established for proper resolution of conflicts and/or inconsistencies. Thus, in a user community similar to a Wiki community, a user is able to participate in the indexing of keywords to the target URLs the user believes to be the best resource. And a user request based on indexed keywords could be effectively and quickly redirected to these relevant, accurate, and authoritative target URLs.

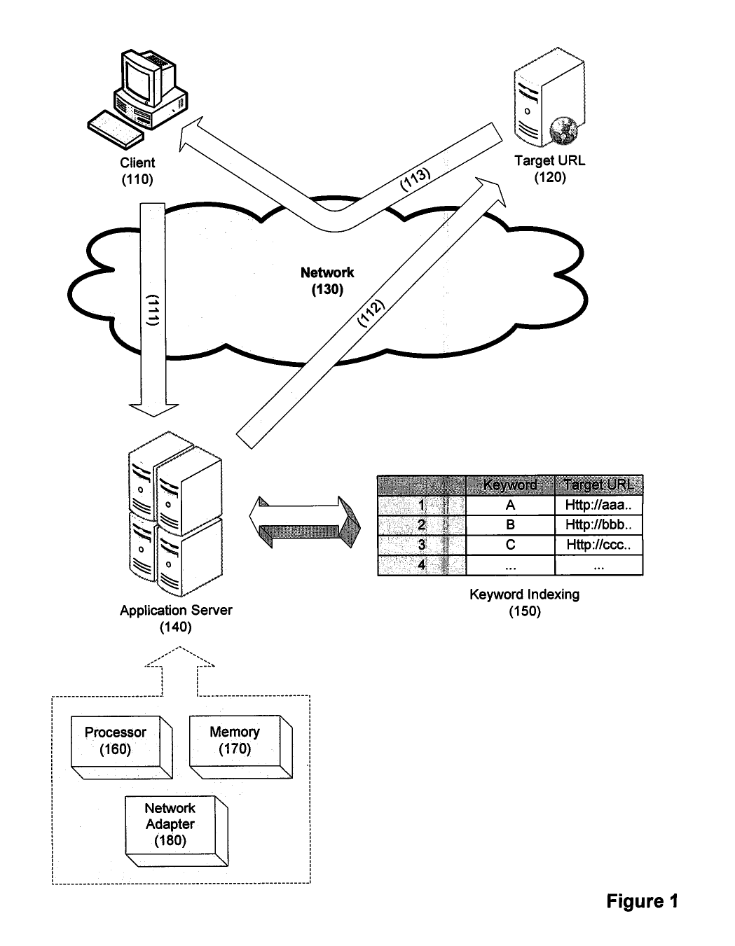

Referring now to FIG. 1, which shows an exemplary networked system environment in which the present invention may be implemented. In FIG. 1, a client 110 is connected to a network 130. The network 130 may be, for example, a local area network (LAN), wide area network (WAN), metropolitan area network (MAN), global area network such as the Internet, a Fibre Channel fabric, or any combination of such interconnects. Client 110 refers to a computer system or a program from which a user request 111 may be originated. Client 110 may be, for example, a conventional personal computer (PC), server-class computer, workstation, handheld computing/communication device, cell phone, or similar devices.

In one embodiment, a user request 111 is sent from client 110 to application server 140. The application server 140 receives various user requests from the client 110, and responds directly or indirectly to these user requests. The application server 140 may contain a web server application such as Apache® HTTP Server, or Microsoft® Internet Information Server, etc, to process user requests in HTTP. Alternatively, the application server 140 may contain customized software programs to handle the user requests. User request 111 is a network communication designated to a specific recipient. Examples of user request 111 include HTTP requests originated from a web browser application, such as a URL input into a web browser's address bar, or HTTP Get or HTTP Put messages originated from a HTML form displayed in the web browser. User request 111 may also be originated from a user-invoked or an event-triggered software program running on client 110.

In one embodiment, application server 140 includes one or more processors 160, memory 170, and network adapter 180. The processor(s) 160 may include central processing units (CPUs) for controlling the overall operation of the application server 130. In certain embodiments, the processor(s) 160 accomplish this by executing software or firmware stored in memory 170. The processor(s) 160 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 170 is or includes the main memory of the application server 140. The memory 170 represents any form of random access memory (RAM), read-only memory (ROM), flash memory (as discussed above), or the like, or a combination of such devices. In use, the memory 170 may contain, among other things, a set of machine instruments which, when executed by processor 160, causing the processor 160 to perform embodiments of the present invention. Also included in the application server 140 is at least one network adapter 180. The network adapter 180 provides the application server 140 with the ability to communicate with remote devices, such as client 110, over the network 130, and may be, for example, an Ethernet adapter or Fibre Channel adapter. In one embodiment, application server 140 is implemented with a computer system with sufficient processing power and storage capacities. Alternatively, application server 140 may be implemented with more than one computer system.

In one embodiment, once the application server 140 receives a user request from client 110, a keyword contained in the user request is extracted and used to retrieve a target URL from keyword indexing 150. Keyword indexing 150 may be maintained and stored by software applications running on application server 140. Keyword indexing 150 may also be managed under a database management system. Data within the keyword indexing 150 may be stored on internal or external physical storage devices, (not shown in FIG. 1) or loaded into the memory 170 of the application server 140. Note that keyword indexing 150 may or may not be in the table format as illustrated in FIG. 1.

In one embodiment, keyword indexing 150 contains direct or indirect associations of keywords with their respective target URLs. A keyword is a word or a phrase used for finding useful results in Internet searches. In situations when multiple words are received from a user request, the multiple words may be treated as a single keyword for the purpose of indexing. Alternatively, each word within the multiple words may be treated as a single keyword, and multiple target URLs may be retrieved based on each word being a keyword. A target URL refers to a target destination in URL format, and may be used for resource locating on the Internet or any other networked environments. The associations in the keyword indexing 150 are established by user inputs and/or the collective intelligence of a user community, which is described in detail below.

In one embodiment, once a target URL is retrieved from the keyword indexing 150 based on the keyword contained in the user request 111, the user request 111 is redirected as a separate request 112 to the target URL 120 (which is an Internet resource accessible via the target URL). Target URL 120 receives the user request 112 redirected from application server 140 and returns with a response 113 to the application server 140. The response 113 is then relayed back to client 110 via application server 140, as a response to the user request 111. Alternatively, in response to the user request 111, a forwarding request containing the target URL is returned from the application server 140 to client 110. Upon receiving the forwarding request, client 110 initiates a second request to the target URL 120, which returns with a response 113 to client 110. Note that FIG. 1 illustrates one of multiple embodiments of redirection in an abstracted, high level overview.

In one embodiment, redirection may be implemented via internal mechanisms of a web browser. Based on a response that includes instruction and destination, such as a status code embedded in the header of a HTTP response, the browser may be instructed to initiate a new forwarding request to the new destination, without the user realizing that the request is being automatically redirected. Alternatively, a server application may initiate a separate request to the target URL, and replace the response to the user request with the response received from the target URL. Further, server-side scripting or programming allows a user request to be redirected with no customized coding. Thus, once client 110 initiates a request, as long as client 110 receives a response that might be originated from a target URL location other than the application server 140, the user request from the client 110 is redirected to the target URL location. From the user's perspective, a response from the redirected target URL is no different from any other response received from a non-redirected target URL.

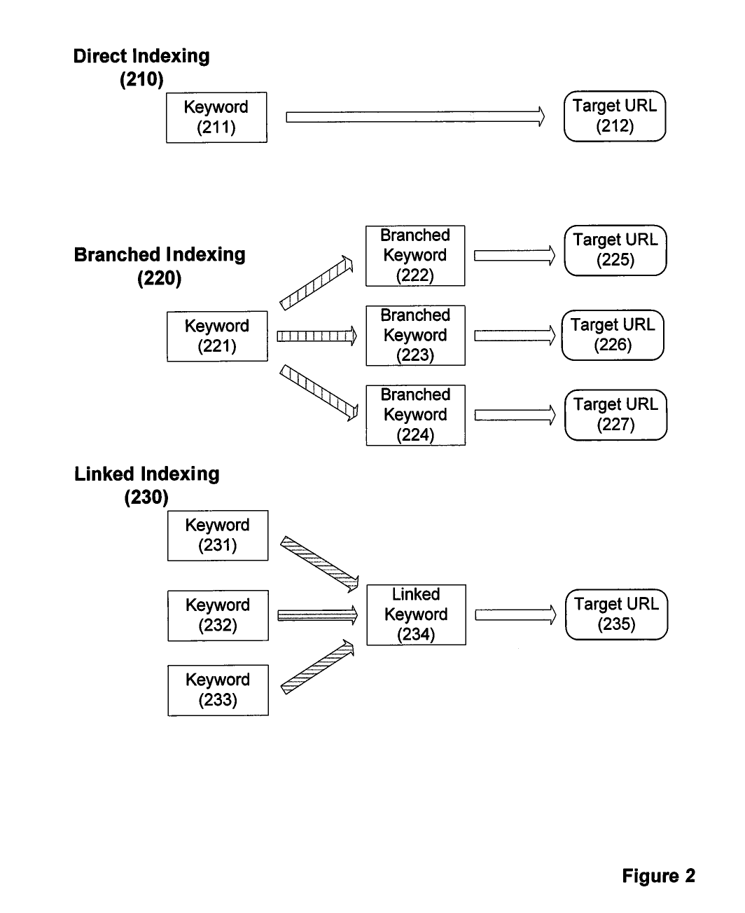

FIG. 2 illustrates exemplary types of keyword indexing in accordance with certain embodiments of the present invention. Indexing, or keyword-URL indexing, or keyword-URL mapping, refers to the direct or indirect association (mapping) between a keyword and its respective target URL, and may be used to create keyword indexing 150 of FIG. 1. In one embodiment, keyword-URL indexing is established and maintained by the collective intelligence of a user community, as disclosed in detail below.

Referring back to FIG. 2, in a direct indexing 210 scenario, a unique keyword 211 is direct-associated with a target URL 212. As such, upon receiving a user request containing keyword 211, the target URL 212 may be retrieved from the direct-association, and be used for redirecting the user request. For example, a keyword such as “sfgiants” would likely be associated with the San Francisco Giants® baseball team. Thus the target URL for keyword “sfgiants” might point to the official home page of the San Francisco Giants. And a user search request based on “sfgiants” would result in the immediate redirect to the official home page with no intermediate “results” page necessary. Therefore, direct-association (represented by pointers with no pattern in FIG. 2) can be utilized to represent a one-to-one relationship between a keyword and a target URL.

In a branched indexing 220 scenario, a keyword 221 is first branch-associated (represented by pointers with vertical patterns in FIG. 2) with multiple branched keywords 222-224, while each of the branched keywords 222-224 is respectively direct-associated with target URLs 225-227. Thus, when keyword 221 is received from a user request, either the user or the present invention may further select one of the branched keywords 222-224, in order to retrieve a target URL for redirecting. For instance, the keyword “giants”, which is more ambiguous than the previous example keyword “sfgiants”, might be referring to either baseball's San Francisco Giants, or football's New York Giants®. In this situation, two branched keywords, which might be suggested by a user, decided by the user community, or automatically generated by the system, may be internally direct-associated with the two equally plausible target URLs for the San Francisco Giants and the New York Giants, before branch-associating with the keyword “giants.”

Alternatively, the branched keywords may already be direct-associated with their respective target URLs before the branch-associations are created. For example, a user might already have created “sfgiants” and “nygiants” keywords that are direct-associated with their respective target URLs. And the keyword “giants” might be branch-associated with keywords “sfgiants” and “nygiants” at a later time. Thus, branch-association may be suitable to represent one-to-many relationships between one keyword and multiple plausible target URLs.

In a linked indexing 230 scenario, keywords 231-233 are link-associated (represented by pointers with horizontal patterns in FIG. 2) with a linked keyword 234, which is direct-associated with a target URL 235. Thus, when a user request with one of the keywords 231-233 is received, the linked keyword 234 may be used to substitute for the received keyword, and the user request may be redirected to the target URL 235 associated with the link keyword 234. For example, common alternative spellings or misspellings might be keywords that are link-associated with a linked keyword during indexing. Thus, a keyword such as “sanfranciscogiants”, or “sfbaseball,” might be linked to linked keyword “sfgiants.” Link-association may be utilized to represent many-to-one relationships between multiple keywords and one target URL.

In one embodiment, a single keyword may maintain multiple types of associations with other keywords. Taking the example of keyword “sfgiants,” which might be direct-associated with a target URL, may be link-associated with a keyword “sanfranciscogiants,” and at the same time be branch-associated with a keyword “giants.” Alternatively, a keyword might be direct-associated with a target URL, while at the same time being link-associated or branch-associated with other keywords. Thus, a user request may have the additional options of either being redirected to the direct-associated target URL, or select a better alternative from the linked or branched keywords. Further, a linked or branched keyword may be link-associated or branch-associated with other keywords, thereby creating multiple layers of associations among keywords.

In another embodiment, indexing may be updated by a user or user community at a later stage to better reflect or organize the keyword-URL mappings. Thus, if the San Francisco Giants decides to move to a different city, or change its name, a better keyword might be more appropriate to direct-associate with its official web site, and all the previous keyword associations may be changed to link-associations or branch-associations accordingly.

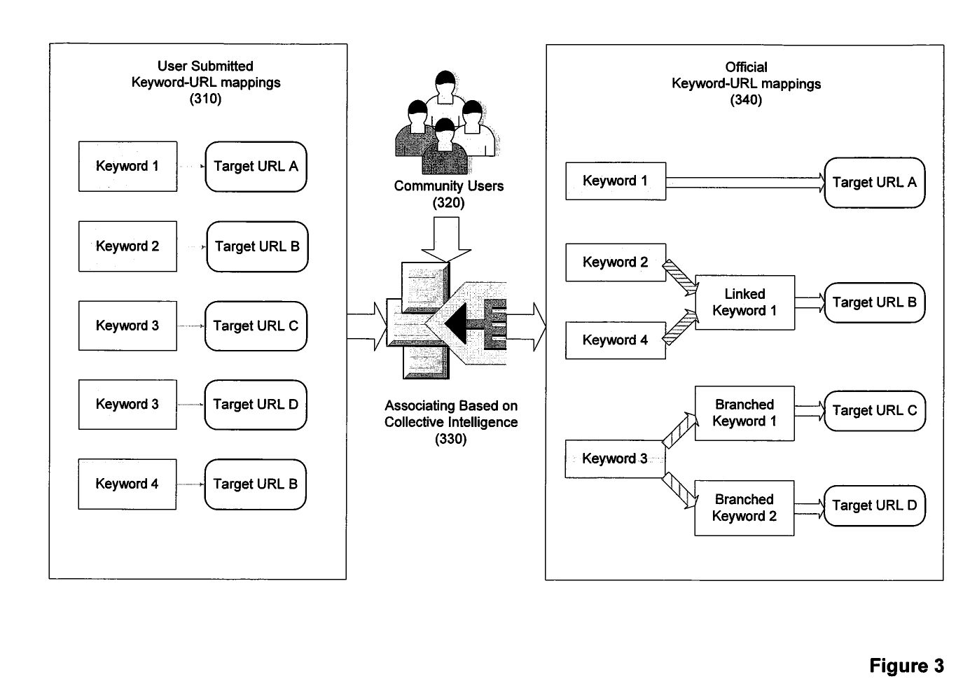

FIG. 3 illustrates exemplary indexing of keywords based on the collective intelligence of a user community, in accordance with certain embodiments of the present invention. In FIG. 3, multiple keyword-URL mappings 310 are submitted by users, and received by an application running on application server 140 of FIG. 1. In situations where there is no existing keyword-URL mapping for a submitted keyword, the submitted mapping may be used to establish the initial direct-associations between the keyword and the target URL. Alternatively, a user might be unsatisfied with the existing associations between a specific keyword with its target URL, and wishes to submit a mapping which the user believes to be more accurate or relevant. The user has the options to either configure his or her submitted keyword to link-associate or branch-associate with the existing keyword, or challenge the existing associations in favor of his own submission. In situations where conflicts or inconsistencies arise between the user submitted mappings and the existing mappings, the collective intelligence of a community 330 of FIG. 3, which constitutes all inputs from community users 320, becomes operative in resolving these conflicts based on a set of predefined community rules and criteria.

In one embodiment, collective intelligence refers to a form of intelligence emerging from the collaboration and competition of a community of users. In a networked environment, each member's individual knowledge and expertise can be pooled together to form a collective whole that is far more than the sum of the individual contributions. This networked environment may be referred to as a collective intelligence community. In some instances, such community may include all Internet users with access to the particular community web site. Alternatively, a community may be created to serve a specific purpose or to promote a common interest. For example, a community may be created to serve redirection requests for hard-to-find antique collections selling on the Internet.

In one embodiment, a community for the purpose of building keyword-URL indexing for redirecting is established. A Wiki-type software may be utilized for the implementation of such a community. A Wiki provides a set of tools to collaboratively create, edit, and organize keyword indexing. A Wiki also provides means to verify the validity, and control the contents of, the user submissions. A Wiki further includes rules and mechanisms to resolve conflicts among the different users' submissions. For example, a set of criteria may be predefined to allow administrators of the Wiki community to allow or reject conflicting submitted mappings.

In one embodiment, a first submitted keyword-URL mapping would be treated as the de facto mapping as long as such mapping is not manipulated for satire or purposes that are deemed offensive or malicious by the community. De facto mapping is subject to later modification or challenges by other users of the community. Multiple suggestions may be preserved for a vote by the community in order to pick the most desirable redirect mapping. Alternatively, an administrator with higher authority may decide for the community, as long as there is no abuse of such authority. In other embodiments, a ranking system would track each individual submitter's prior contributions in quality and frequency of their prior submissions. Thus, a higher ranked user's input may have the priority over a lower ranked user's input, and may be selected as the official keyword-URL mapping.

To minimize conflicts, a neutral point of view (NPOV) may be embodied in the selection of criteria for determining the best redirect for a particular keyword. While “subjective” criteria for community determination of proper redirects are envisioned in certain circumstances, it is more likely that neutral or “objective” criteria produce a more satisfactory result for the community. For example, the subjective criteria “best website” may be implemented for certain subject matters. However, “best” is usually a subjective concept that is bound to have significant community disagreements for redirection. Thus, for certain subject matters, e.g., “official” designated web sites, or single authoritative sources, etc, objective criteria, or NPOVs, may be implemented to produce consensus in the community as being the “correct” configured redirects.

Referring back to FIG. 3, based on the inputs from the community users 320, a set of “official” keyword-URL mappings 340 is established. Taking the user submitted mappings 310 as an example, based on the consensuses of the collective intelligence 330, keyword 1 is direct-associated with target URL A. Because keyword 2 and keyword 4 are both trying to map to target URL B, the collective intelligence of the community might determine that a linked keyword 1 should be direct-associated with target URL B, and keyword 2 and keyword 4 may instead be link-associated with link keyword 1. Thus, a user request with either keyword 2 or keyword 4 would be substituted with linked keyword 1 for retrieval of target URL B, and the user request would be redirected to target URL B. Alternatively, the community may pick one of the keywords 2 and 4 to be direct-associated with target URL B, and the other one to be link-associated with the picked keyword. Or, the community may reject one in favor of the other, between keyword 2 and keyword 4 for direct-association with target URL B.

Likewise, keyword 3 is mapped to two different target URLs, C and D in user submitted keyword-URL mappings 310. In one embodiment, the collective intelligence may determine that two additional branched keywords 1 and 2 may be better suited to be direct-associated with target URLs C and D, and keyword 3 may be branch-associated with branched keywords 1 and 2, so that a user request based on keyword 3 may further select between the alternative branch keywords to better clarify his or her intent. Alternatively, the collective intelligence may determine that one of the two target URLs is better than the other one, thus establishing the better one as the “official” target URL for keyword 3, and rejecting the other target URL.

In one embodiment, a set of software tools may be provided to efficiently build and maintain the redirect application. For example, algorithms can be created to monitor activities, redirects, and/or searches and distribute improvement tasks based on the frequency of keyword searches and other relevant data. Further, community tools may be provided to effectively deal with abuse and misuse of the system, thus improving the user experience. In addition, incentives for users to contribute and improve the whole of the implementation may also be provided to the community, monetary and/or non-monetary. For example, user recognition, user levels/ratings, special privileges, and/or extra responsibilities may be given to users who contribute qualitatively and/or quantitativly.

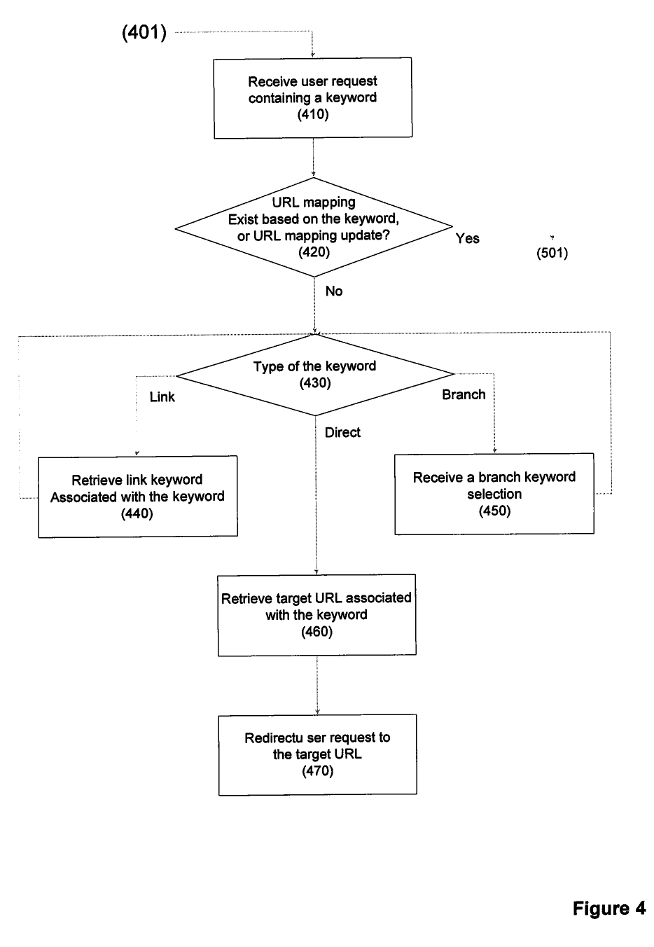

FIG. 4 illustrates an exemplary flowchart for a method 401 in accordance with one embodiment of the present invention. The method 401 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 401 is executable by processor 160 of application server 140 in FIG. 1.

In one embodiment, at block 410 of FIG. 4, a user request containing a keyword is received. At block 420, the received keyword is used to locate a keyword-URL mapping. If the keyword-URL mapping is not found, or if the user is intended to challenge/update the existing keyword-URL mapping, method 410 goes on to perform actions of method 501, which is described below. When the keyword-URL mapping is found, the type of association with respect to the keyword is assessed at block 430. Based on the type of the keyword association, if the keyword has a direct-association with a target URL, then the method 401 proceeds to block 460, at which the target URL associated with the keyword is retrieved.

Alternatively, if the keyword association is a link-association at block 430, method 401 proceeds to block 440, at which a linked keyword is retrieved to substitute the keyword received via the user request. The linked keyword is then again being assessed at block 430 for its type. Similarly, if the type of keyword association is found to be a branched one at block 430, then at block 450, an additional user input is received to select a branch keyword from the list of branch keywords associated with the keyword in the user request. Thereafter, the type of the selected branch keyword is also checked at block 430. Eventually, a direct-association is obtained at block 430, and a target URL is retrieved at block 460. The target URL is thus utilized to redirect user request to the target URL at block 470.

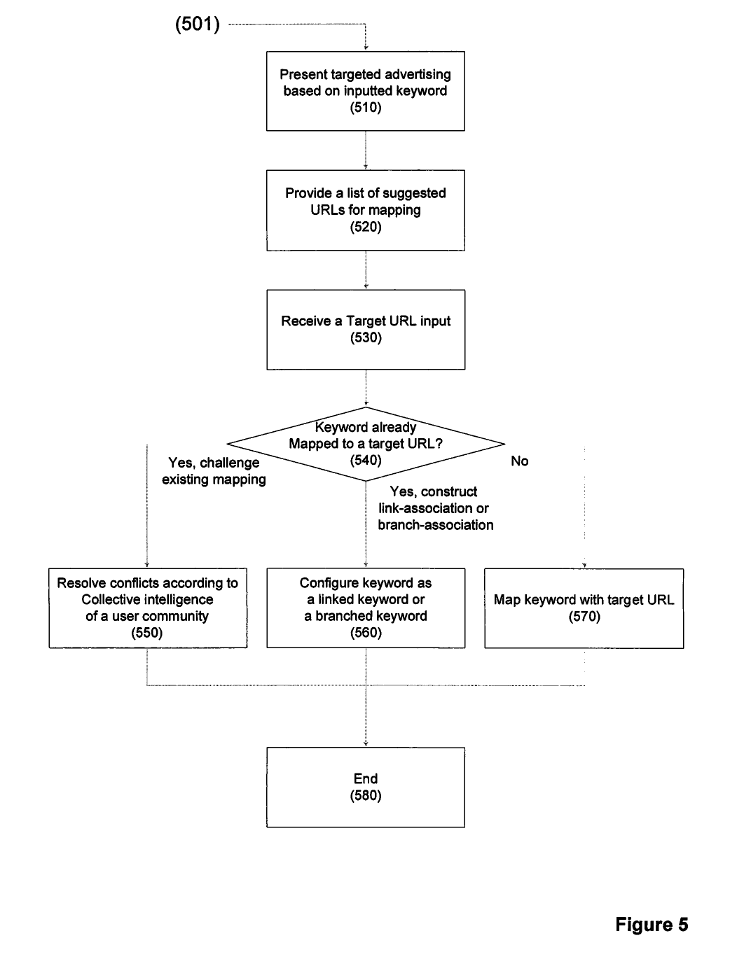

FIG. 5 illustrates an exemplary flowchart of a method 501 in accordance with one embodiment of the present invention. The method 501 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 401 is executable by processor 160 of application server 140 in FIG. 1.

In one embodiment, when no mapping is located, or when a user intends to challenge/update the existing mapping, at block 420 of FIG. 4, method 401 of FIG. 4 proceeds to perform method 501 of FIG. 5. Alternatively, a user may invoke method 501 through user interfaces provided by a Wiki-type application. Thus, at block 510, based on the keyword the user is interested in, a selected arrangement of targeted advertisements is presented along with any additional information related to the selection of keywords and inputting of a target URL. Such an approach is advantageous since it provides users with alternatives to the target URL they have in mind. It also provides advertising revenue to the community operator for recouping operational costs. Block 510 may be optional, as it is not essential to the operation of keyword indexing. Also, users may or may not click-through any of the displayed advertisement materials and links.

In one embodiment, at block 520, a list of suggested URLs for mapping with the keyword is provided. Such list of suggested URLs may be generated from search results from other search engines. It may also be generated by other users of the community in guiding the construction of the community redirect. Alternatively, suggestions may include, target URLs that are already associated with keywords, or any related keywords that can be utilized for constructing link-associations or branch-associations. At block 530, a target URL selection is received from the user. The target URL may either be picked from the list of suggestions provided at block 520, or inputted by the user in lieu of the suggestions. The target URL received at block 530 may or may not be used for keyword indexing, depending on the determination of the collective intelligence of the user community.

In one embodiment, block 540 performs a determination as to whether the keyword already has a target URL mapping in existence. If the answer to block 540 is no, then the method 501 proceeds to block 570, at which the keyword is associated with the target URL as the de facto mapping. If block 540 determination indicates that a previous mapping already in existence in the system, the user may decide to reconcile the conflict between his submission and the existing keyword mapping by constructing either a branch-association or a link-association. In such case, method 501 proceeds to block 560, at which the user is provided with a set of tools to reconstruct the associations among the existing keywords, existing target URLs, his submitted keyword, and/or his submitted target URL. Also, the updates may be subject to the collective intelligence of the user community for approval.

If the user intends to challenge the existing mapping at block 540, method 501 proceeds to block 550, at which the user submitted keyword-URL mapping would be put into the community for conflict resolution. In one embodiment, a user with higher ranking/level/authority would prevail over a lower ranked user in determining whose mapping should be deemed “official”. Also, a neutral administrator might be requested to review the selection of akeyword-URL mapping, or to determine whether setting up a link-association or a branch-association is more appropriate. Further, a voting system might be implemented for democratic selection of the best mapping.

For example, if a user submits a keyword-URL mapping for “giants” to the San Francisco Giants' official web site, while a previous mapping of “sfgiants” to the same target URL is already in existence, the user may configure his “giants” keyword to be link-associated with the “sfgiants” keyword at block 560, or configure the “giants” keyword to be branch-associated with keyword “sfgiants” at block 560. Alternatively, the user may leave his original submission to the community control, so that the collective intelligence of the community could resolve the conflict according to a predefined set of rules and criteria. The outcome of the collective intelligence may be either rejection of his submission, acceptance of his submission over the existing mapping, acceptance of his submission as a link-association to a linked keyword, or acceptance of his submission as a branch-association to a branched keyword.

Once the keyword-URL mapping is established, method 501 proceeds to block 580 for completion. The constructed mapping is then ready for redirecting user requests.

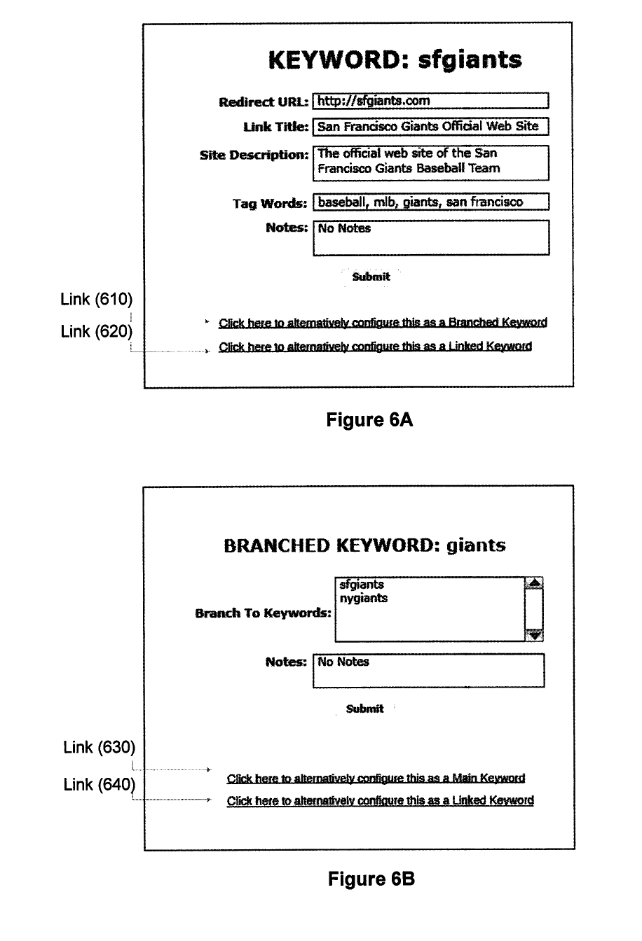

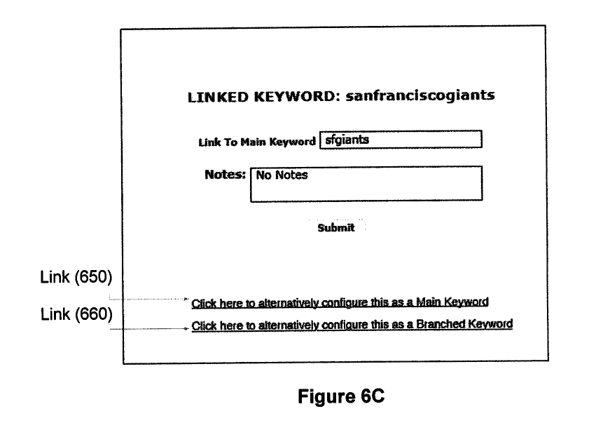

FIGS. 6A-6C illustrate exemplary user interfaces in implementing keyword-URL mapping, in accordance with embodiments of the present invention. The layout, function, and/or context of the graphic elements within FIGS. 6A-6C may be implemented in a web application, a Graphic User Interface (GUI) application, or the combination thereof. FIG. 6A shows a keyword “sfgiants” to be mapped to a redirect target URL “http://sfgiants.com.” Optional fields such as “Link Title”, “Site Description”, “Tag Words”, and “Notes” are metadata that may improve the usability and/or functionality of the system as a whole. A “submit” button is provided for the triggering of submission of the configuration information in the FIG. 6A user interface. Once submitted, the system may perform methods similar to method 501 of FIG. 5.

Referring back to FIG. 6A, links 610 and 620 provide user alternative options for configuring the keyword as a branched or a linked keyword. When a user invokes link 610 to setup branch-association, a user interface as illustrated in FIG. 6B may be activated for user selection. Similarly, invocation of link 620 would activate a user interface as illustrated in FIG. 6C for the configuration of link-association.

FIG. 6B illustrates a user interface during set up of branch-association for the keyword “giants.” In FIG. 6B, multiple branched keywords, e.g., “sfgiants” and “nygiants” may be displayed and/or inputted for setting up branch-associations with the keyword “giants.” If the user is satisfied with the selection, by clicking the “Submit” button, branch-associations may be created. Further, the keyword “giants” may be configured as a main keyword or a linked keyword when a user invokes link 630 or 640, respectively. A main keyword refers to a keyword with direct-association to a target URL. In one embodiment, keywords may be configured to have direct-association and branch-association at the same time.

FIG. 6C illustrates a user interface during set up of a link-association relationship for the keyword “sanfranciscogiants.” In FIG. 6C, a link-to keyword “sfgiants” is either suggested by the system, or inputted in by the user. And clicking the “Submit” button would result in the generation of link-association between the keywords. Further, the keyword “sanfranciscogiants” may be configured as a main keyword or a branched keyword when a user invokes link 650 or 660, respectively. In one embodiment, keywords may be configured to have direct-association and link-association at the same time.

Thus, methods and systems for implementing a URL redirect based on Wiki-type collective intelligence have been described. The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method, comprising:
receiving a user request containing a keyword;
retrieving a target URL, wherein the target URL is associated with the keyword based on collective intelligence of a user community; and
redirecting the user request to the target URL, in response to the user request.

2. The method as recited in claim 1, wherein the user request is an HTTP request.

3. The method as recited in claim 1, wherein the collective intelligence of the user community is to establish consent of the user community based on a set of predefined criteria.

4. The method as recited in claim 1, wherein the collective intelligence of the user community associates a plurality of keywords with a plurality of target URLs with respect to a specific subject matter.

5. The method as recited in claim 1, wherein the target URL is associated with a branch keyword selected from a plurality of keywords, each of the plurality of keywords being derived from the keyword contained in the user request, and associated with a corresponding target URL.

6. The method as recited in claim 1, wherein the target URL is associated with a linked keyword, the linked keyword being a substitute of the keyword contained in the user request.

7. The method as recited in claim 1, wherein the method is embodied in a machine-readable medium as a set of instructions which, when executed by a processor, cause the processor to perform the method.

8. A method, comprising:
receiving a user input of a keyword;
receiving a target URL adapted to redirect a user request containing the keyword to the target URL; and
associating the keyword with the target URL, wherein the association is determined based on collective intelligence of a user community.

9. The method as recited in claim 8, wherein the user input is via an HTTP request.

10. The method as recited in claim 8, wherein the target URL is received upon a determination that the keyword is not yet associated with any target URL.

11. The method as recited in claim 8, wherein the target URL is selected from a plurality of suggested target URLs.

12. The method as recited in claim 11, wherein the plurality of suggested target URLs includes search engine results based on the keyword.

13. The method as recited in claim 8, wherein said associating is established through a plurality of branched keywords, each of the plurality of branched keywords being derived from the keyword, the target URL being associated with one of the plurality of branched keywords.

14. The method as recited in claim 8, wherein said associating is established through a linked keyword, the linked keyword being associated with the target URL.

15. The method as recited in claim 8, wherein the collective intelligence of the user community is to establish consent of the user community based on a set of predefined criteria.

16. The method as recited in claim 8, wherein the collective intelligence of the user community associates a plurality of keywords with a plurality of target URLs with respect to a specific subject matter.

17. The method as recited in claim 8, further comprising:
presenting a plurality of targeted advertisements related to the keyword upon receiving of the user input of the keyword.

18. The method as recited in claim 8, further comprising:
resolving a conflict between the target URL and an existing target URL based on the collective intelligence of the user community, wherein the existing target URL is associated with the keyword.

19. The method as recited in claim 8, wherein the method is embodied in a machine-readable medium as a set of instructions which, when executed by a processor, cause the processor to perform the method.

20. A method, comprising:
establishing a user community for redirecting a user request containing a keyword;
associating a plurality of keywords with a plurality of target URLs, wherein said associating is based on collective intelligence of the user community; and
redirecting the user request to a target URL, wherein the keyword is one of the plurality of keywords, the target URL is one of the plurality of target URLs, and the keyword is associated with the target URL.

21. The method as recited in claim 20, wherein the keyword is associated with a plurality of branched keywords selected from the plurality of keywords, each of the plurality of branched keywords being derived from the keyword, the target URL being associated with one of the plurality of branched keywords.

22. The method as recited in claim 20, wherein the keyword is associated with a linked keyword, the linked keyword being associated with the target URL.

23. The method as recited in claim 20, wherein the collective intelligence of the user community is to establish consent of the user community based on a set of predefined criteria.

24. The method as recited in claim 20, further comprising:
presenting a plurality of targeted advertisements related to the keyword.

25. The method as recited in claim 20, wherein the method is embodied in a machine-readable medium as a set of instructions which, when executed by a processor, cause the processor to perform the method.
